(19) United States
(12) Patent Application Publication
(10) Pub. No.: US 2017/0289525 A1
(43) Pub. Date: Oct. 5, 2017

(54) PERSONAL 3D PHOTOGRAPHIC AND 3D VIDEO CAPTURE SYSTEM

(71) Applicant: Charles Wivell, Young America, MN (US)

(72) Inventor: Charles Wivell, Young America, MN (US)

(21) Appl. No.: 15/467,579

(22) Filed: Mar. 23, 2017

Related U.S. Application Data
(60) Provisional application No. 62/315,858, filed on Mar. 31, 2016.

(51) Int. Cl. H04N 13/02; H04N 13/04; G03B 15/00; G03B 17/56; F16M 11/32

(52) U.S. Cl. CPC H04N 13/0239; G03B 17/561; G03B 17/563; H04N 13/0296; F16M 11/32; G03B 15/006; H04N 13/04; H04N 2213/001

(57) ABSTRACT

A personal 3D photographic and 3D video capture system includes multiple cameras separated in space using a rigid structure; a wired or wireless method to control the image or video acquisition for all cameras; a processing unit; a wired or wireless method to download the imagery and video to the processing unit; software to accurately align the imagery and video frames in space and time, combine the imagery and video into standard 3D formats and save the imagery and video into a file for later viewing.

### CROSS-REFERENCE TO RELATED APPLICATION

The present application is based on and claims the benefit of U.S. provisional patent application Ser. No. 62/315,858, filed Mar. 31, 2016, the content of which is hereby incorporated by reference in its entirety.

### BACKGROUND

Users of personal photographic and video systems do not have a simple way to capture 3D/stereo imagery and video that can be quickly viewed on 3D capable viewing devices, such as but not limited to: 3D TVs, 3D computer monitors, and virtual and augmented reality devices.

### SUMMARY

In accordance with one embodiment, a camera mount includes a rigid structure having a first surface and a second surface opposite the first surface. At least one receptacle is positioned in the first surface such that the rigid structure is capable of being mounted to a second camera mount for a single device. At least two connectors are positioned on the second surface such that the rigid structure is capable of receiving and securing two devices containing cameras.

In a further embodiment, a stereo camera system includes a rigid camera mount holding a first camera and a second camera a fixed distance apart. A trigger mechanism triggers both the first camera and the second camera at a same time to generate a first image and a second image. A processor executes an alignment tool that aligns the first image with the second image to generate image data that can construct a three-dimensional image on a three-dimensional display.

In a still further embodiment, a stereo camera includes a first image sensor array aligned with a first camera aperture and a second image sensor array aligned with a second camera aperture. A shutter control is linked to the first image sensor array and to the second image sensor array such that activation of the shutter control causes the first image sensor array to collect first image data and the second image sensor array to collect second image data. The camera further includes a processor that receives the first image data and the second image data and constructs three-dimensional image data from the first image data and the second image data. The three-dimensional image data such that a corresponding image looks three-dimensional when the three-dimensional image data is applied to a three-dimensional display.

### BRIEF DESCRIPTION OF THE DRAWINGS

FIG. 1 is a sectional view of a camera mount designed to hold to cameras and be held by another camera mount in accordance with some embodiments.

FIG. 2A is a front view of a stereo camera in accordance with one embodiment.

FIG. 2B is a back view of a stereo camera in accordance one embodiment.

FIG. 3 provides a block diagram of a system used to implement various embodiments.

FIG. 4 is a block diagram of a mobile device having a camera.

FIG. 5 is a block diagram of a computing device that can be used to implement a server.

### DETAILED DESCRIPTION OF ILLUSTRATIVE EMBODIMENTS

### Scenario 1:

### 3D/Stereo Selfie Stick Still Images:

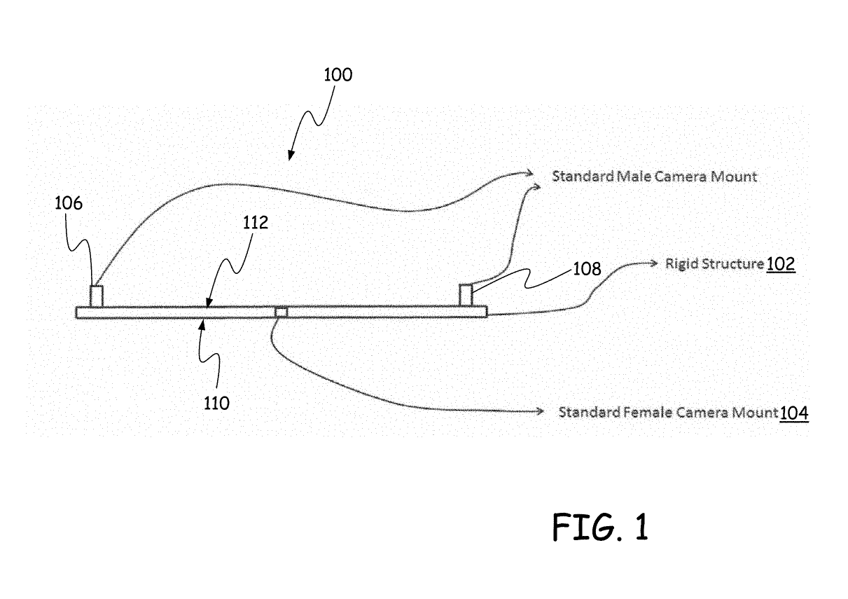

FIG. 1 provides a section view of a camera mount 100. In accordance with one embodiment, camera mount 100 includes a ridged structure 102 with a standard female receptacle 104 that can be mounted on a selfie stick standard male camera mount. The ridged structure also contains at least two standard male camera mounts 106 and 108 separated by 0.25 to 2.0 feet. Male camera mounts 106 and 108 can hold and support two separate mobile devices with embedded cameras or two separate cameras. In accordance with the embodiment of FIG. 1, female receptacle 104 is located on a first surface 110 of rigid structure 102 and male camera mounts 106 and 108 are located on a second surface 112 of rigid structure 102, opposite first surface 110.

In accordance with one embodiment, male camera mounts 106 and 108 are designed to support and hold a cell phone

In such embodiments, each cell phone contains a software application that permits each cell phone to capture an image at a same time and to provide the image to an alignment tool that aligns the images and constructs three-dimensional image data from the two images.

In use, a user places two phones in camera mount 100 and starts the software application. The user points the apertures of the cameras in the cell phones toward a scene to be captured. The user uses a shutter release to acquire the images simultaneously on each cellphone camera. The two acquired images are provided to the alignment tool, which aligns the images based on features in the images. The aligned images are then used to construct three-dimensional image data that can be displayed on a three-dimensional display. In accordance with one embodiment, the three-dimensional image data is stored in an image file using a three-dimensional image format.

There are several embodiments of the shutter trigger mechanism. A first embodiment uses a wireless shutter release connection to control the shutters of both of the cellphone cameras. A second embodiment uses a wired shutter release connection from the selfie stick to each of the cellphones. A third embodiment uses a wired shutter release connection to one of the cellphones (the Master) and a wireless shutter release connection between the Master and the second cellphone's (the Slave) camera. A fourth embodiment has a wired shutter release connection to the Master Cellphone from the selfie stick and a wired shutter release connection between the Master cellphone and the Slave cellphone. A fifth embodiment uses a wireless shutter release connection to the Master cellphone and a wired shutter release connection from the Master to the Slave.

The alignment tool can be located on one or both of the cellphones or can be located on a separate computing device. Before the images can be aligned, they must be provided to the device that executes the alignment tool. For example, when the alignment tool is on one of the cellphones, the other cellphone sends its image to the cellphone that has the alignment tool. The image can be sent over a wired or wireless connection. Alternatively, both cellphones can send their images to a separate computing device that executes the alignment tool. The images can be sent over a wired or wireless connection and an image from one cellphone can pass through the other cellphone on the way to the separate computing device.

### Scenario 2:

### 3D/Stereo Selfie Stick Videos:

The setup of the cellphones on the selfie stick is the same as for the still image scenario, except the cameras on the cellphones are placed into the video capture mode. The control of the start and stop of the video will use any of the options listed in scenario 1.

The user will start the video and acquire as much video as desired. The user will have the option of processing the videos on one of the cellphones or download the two videos onto a standalone computer, which executes the alignment tool. With either option, the videos will be aligned in time using Global Positioning System (GPS) timestamps acquired from each cellphone at the start of the video. Alternatively, the frames of the videos are synchronized while collecting the videos using an accurate time reference such as the GPS time. Each corresponding frame of the videos will be aligned more precisely in space. The video corresponding to the video frames will be combined and placed into a standard 3D video format and will be saved to a file.

### Scenario 3:

### 2 Small Dedicated Video Cameras for the Creation of 3D Videos

In a further embodiment, small dedicated video cameras are mounted on a rigid structure such as, but not limited to handle bars or a helmet with a separation between the cameras of 0.25 to 2.0 feet. The user aligns the cameras so that they are acquiring approximately the same scenes. The user will start the video on each camera as close to simultaneously as possible or may use a linked shutter release system like those mentioned in scenario 1. In accordance with one embodiment, the frames of the videos are captured in a synchronized manner using an accurate time reference such as the GPS time. After acquiring the desired amount of video, the user downloads the videos from both cameras to a standalone computer which executes the alignment software. In accordance with some embodiments, each video file has at least one timestamp, such as a Global Positioning System timestamp that indicates when the video was captured. The alignment software uses the timestamps if they are available or the alignment software aligns the frames of the videos in time using image matching techniques on the frames of the two videos. The alignment software then aligns the corresponding frames within the two videos and combines the frames into a standard 3D video format. The 3D video is then saved to a file.

### Scenario 4:

3D/Stereo Still Photography using a Tripod:

In a still further embodiment, two standard Digital Single-Lens Reflex (DSLR) cameras are mounted on a rigid structure and separated by 0.25 to 2.0 feet and the rigid structure is mounted onto a standard tripod, using a standard mount on the rigid structure. The user aligns the cameras so that they image approximately the same scene. The user uses either a wireless or wired shutter release to simultaneously acquire the images to each of the cameras. The user downloads the images to a standalone computer which executes the alignment tool software. The alignment tool software aligns the images and combines them into a standard three-dimensional format and saves the results to a file. The three-dimensional format allows a three-dimensional image to be displayed on a three-dimensional display.

### Scenario 5:

### A Self-Contained 3D/Stereo Still and Video:

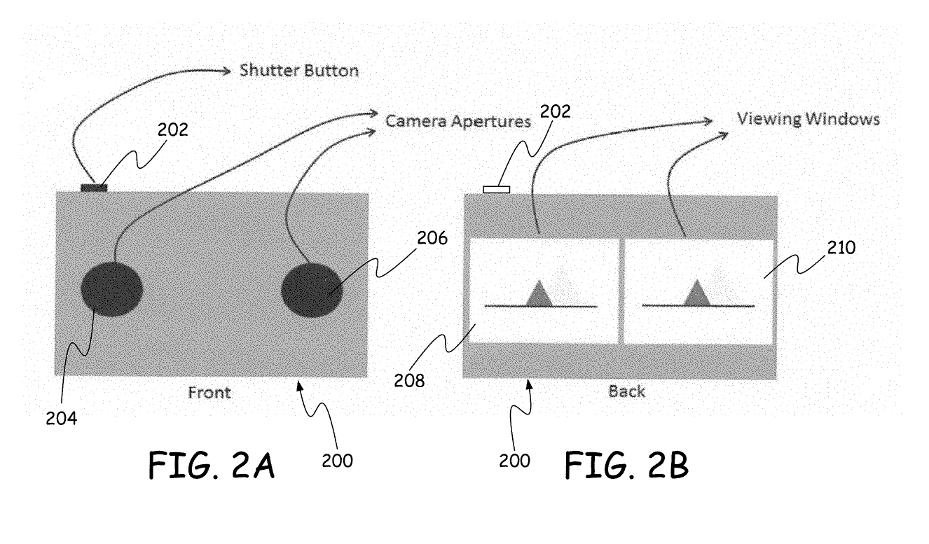

FIGS. 2A and 2B provide a front view and a back view of a stereo camera 200 used in a further embodiment.

Camera 200 includes a shutter button 202 and two camera apertures 204 and 206. In addition camera 200 includes two separate light sensing arrays (internal to camera 200) that are each aligned with a respective one of the two camera apertures 204 and 206. Each light sensor array provides a plurality of image values from light passing through the array's respective camera aperture. Camera 200 also includes two displays 208 and 210, that display the image currently received by a respective light sensing array or an image recently captured by a respective light sensing array.

During use, a user selects either a still mode or a video mode. In the still mode the user uses shutter button 202 to acquire images on both of the light sensor arrays simultaneously. Alignment software is executed by a processor in camera 200 to align and combine the two images into one of many standard 3D formats and save the results to a file.

In the video mode, the user presses the shutter button to cause both light sensing arrays to begin capturing a plurality of frames of images. Each frame of the video is aligned and combined into one of many standard three-dimensional video formats by the processor executing the alignment software. The resulting three-dimensional video is saved to a file.

### Scenario 6:

### 3D/Stereo Video Acquired by a Drone:

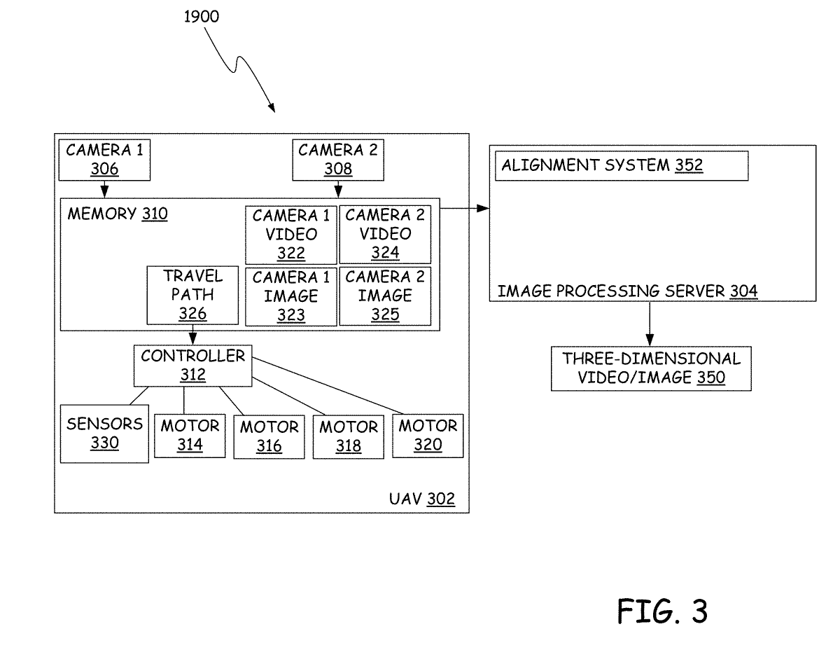

In a further embodiment, a system 300 of FIG. 3 is used to capture images and video into three dimensional images and three-dimensional video. System 300 includes UAV 302 and image processing server 304. UAV 302 includes a first camera 306 and a second camera 308, a memory 310, a controller 312 and motors, such as motors 314, 316, 318 and 320. Camera 306 provides camera 1 video 322 and camera 1 still images 323, which are stored in memory 310, and camera 308 provides camera 2 video 324 and camera 2 still images 325, which are also stored in memory 310. A travel path 326 is stored in memory 310 and represents the path that UAV 302 is to travel to capture images and video. Travel path 326 is provided to controller 312, which controls motors 314, 316, 318 and 320 to drive propellers so that UAV 302 follows travel path 326. One or more sensors, such as sensors 330 provide feedback to controller 312 as to the current position of UAV 302 and/or the accelerations that UAV 302 is experiencing. One example of sensors 330 is a Global Positioning System antenna.

In accordance with one embodiment, controller 312 controls when first camera 306 and second camera 308 collect images and video. In a still further embodiment, controller 312 synchronizes the collection of frames of video by first camera 306 and second camera 308 using an accurate time reference such as the GPS time.

Periodically or in real-time, UAV 302 provides camera videos 322 and 324 and or camera still images 323 and 325 to image processing server 304. Videos 322 and 324 and images 322 and 324 may be provided over a wireless connection, a wired connection, or a combination of both between UAV 302 and image processing server 304. Image processing server 304 executes alignment software 352 to align frames of camera video 322 with frames of camera video 324 or to align still image 323 with still image 325 so as to produce three-dimensional image data that can be displayed on a three-dimensional display to form a three-dimensional video or a three-dimensional image 350. In accordance with one embodiment, alignment software 352 uses either GPS timestamps or image matching techniques to align the frames of camera video 322 with the frames of camera video 324. In addition, alignment software 352 aligns the corresponding frames and combines the frames into a 3D video format. In accordance with one embodiment, camera 306 and camera 308 are mounted on a rigid structure on UAV 302 and are separated from each other by over 0.25 feet. Controller 312 can activate cameras 306 and 308 to capture video 322 and video 324 or a user can activate cameras 306 and 308 to capture video 322 and video 324 before UAV 302 starts along travel path 326.

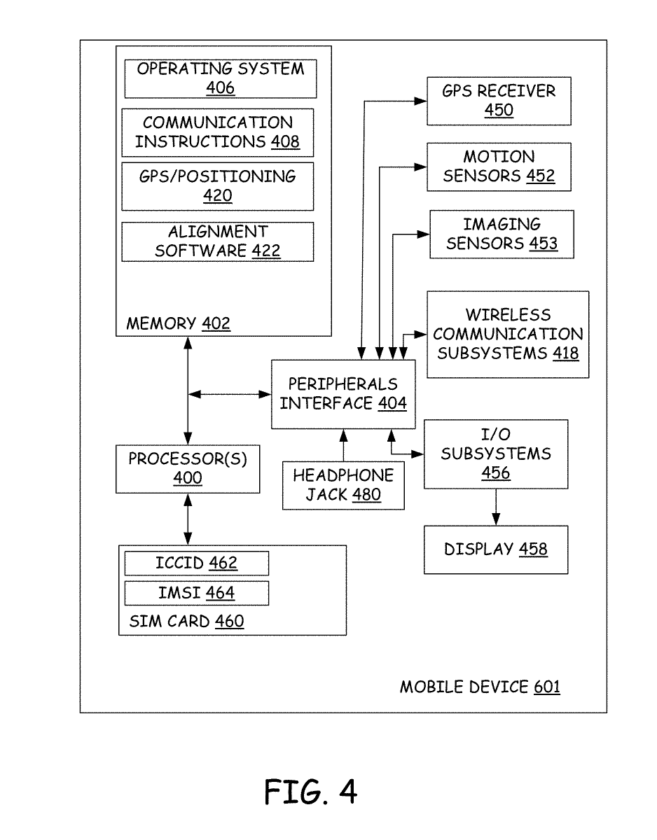

FIG. 4 provides a block diagram of a mobile device 401, which is an example implementation of a mobile device with a camera discussed above. Mobile device 401 includes one or more processors 400, such as a central processing unit or image processors, and a memory 402. Processor(s) 400 and memory 402 are connected by one or more signal lines or buses. Memory 402 can take the form of any processor-readable medium including a disk or solid-state memory, for example. Memory 402 includes an operating system 406 that includes instructions for handling basic system services and performing hardware-dependent tasks. In some implementations, operating system 406 can be a kernel. Memory 402 also includes various instructions representing applications that can be executed by processor(s) 400 including communication instructions 408 that allow processor 400 to communicate through peripherals interface 404 and wireless communication subsystems 418 to a wireless cellular telephony network and/or a wireless packet switched network. Memory 402 can also hold alignment software 422 and GPS/Positioning instructions 420.

Peripherals interface 404 also provides access between processor(s) 400 and one or more of a GPS receiver 450, motion sensors 452, imaging sensor array 453, headphone jack 480 and input/output subsystems 456. GPS receiver 450 receives signals from Global Positioning Satellites and converts the signals into 3D location information such as longitudinal, latitude and altitude information describing the location of mobile device 401. In particular, each satellite signal contains a clock signal. In accordance with one embodiment, processor 400 uses the clock signal to timestamp videos collected by imaging sensor array 453. Alternatively, processor 400 uses the clock signal to synchronize the collection of video frames with another camera. The position of mobile device 401 may also be determined using other positioning systems such as Wi-Fi access points, television signals and cellular grids. Motion sensors 452 can take the form of one or more accelerometers, a magnetic compass, a gravity sensor and/or a gyroscope. Motion sensors 452 provide signals indicative of movement or orientation of mobile device 401. I/O subsystems 456 control input and output for mobile device 401. I/O subsystems 456 can include a touchscreen display 458, which can detect contact and movement or break thereof using any of a plurality of touch sensitivity technologies including, but not limited to capacitive, resistive, infrared and surface acoustic wave technologies as well as other proximity sensor arrays or other elements for determining one or more points of contact with display 458. Other inputs can also be provided such as one or more buttons, rocker switches, thumb wheel, infrared port, USB port and/or pointer device such as a stylus. Headphone jack 480 provides an input/output that can be used as part of the wired shutter triggering mechanism discussed above.

Mobile device 401 also includes a subscriber identity module, which in many embodiments takes the form of a SIM card 460. SIM card 460 stores an ICCID 462 and an IMSI 464. ICCID 462 is the Integrated Circuit Card Identifier, which uniquely identifies this card on all networks. IMSI 464 is the international mobile subscriber identity, which identifies the SIM card on an individual cellular network. When communicating through wireless communication subsystems 418, processor(s) 400 can use identifiers 462 and/or 464 to uniquely identify mobile device 401 during communications. In accordance with many embodiments, SIM card 460 is removable from mobile device 401 and may be inserted in other devices.

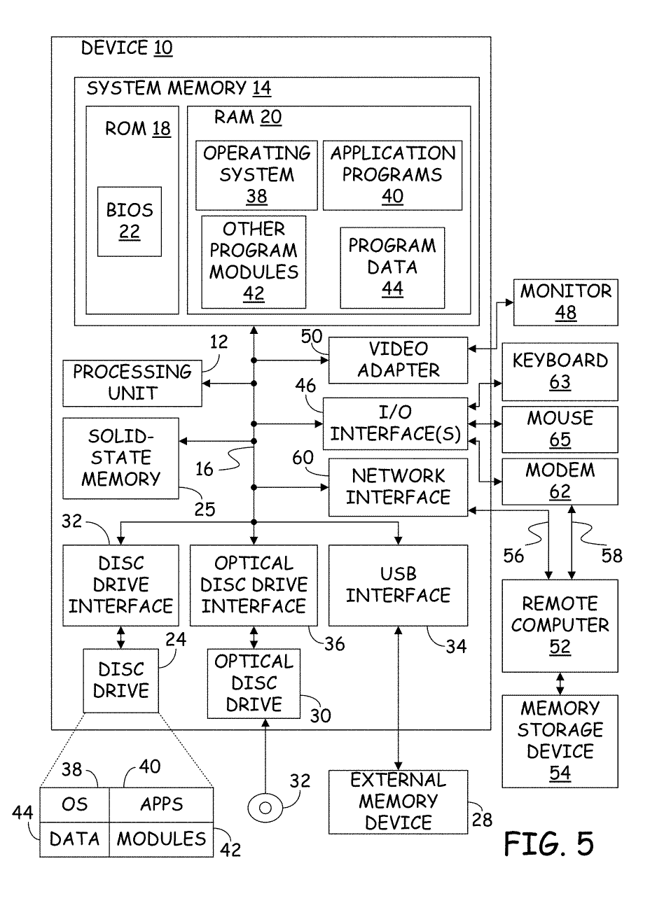

An example of a computing device 10 that can be used as a server or separate computing device in the various embodiments is shown in the block diagram of FIG. 5. For example, computing device 10 may be used as server 410. Computing device 10 of FIG. 5 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for alignment software, such as alignment software 352. Program data 44 can include image and video data from two separate cameras as well as the completed three-dimensional image data file formed by the alignment software.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 5. The network connections depicted in FIG. 5 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 5 are exemplary and other means for establishing a communications link between the computers, such as a wireless interface communications link, may be used.

Although elements have been shown or described as separate embodiments above, portions of each embodiment may be combined with all or part of other embodiments described above.

Although the present invention has been described with reference to preferred embodiments, workers skilled in the art will recognize that changes may be made in form and detail without departing from the spirit and scope of the invention.

What is claimed is:

1. A camera mount comprising:
a rigid structure having a first surface and a second surface opposite the first surface;
at least one receptacle positioned in the first surface such that the rigid structure is capable of being mounted to a second camera mount for a single device;
at least two connectors positioned on the second surface such that the rigid structure is capable of receiving and securing two devices containing cameras.

2. The camera mount of claim 1 wherein the second camera mount is attached to a selfie stick.

3. The camera mount of claim 1 further comprising at least one wire for triggering a shutter of a camera.

4. A stereo camera system comprising:
a rigid camera mount holding a first camera and a second camera a fixed distance apart;
a trigger mechanism triggering both the first camera and the second camera at a same time to generate a first image and a second image; and
a processor executing an alignment tool that aligns the first image with the second image to generate image data that can construct a three-dimensional image on a three-dimensional display.

5. The stereo camera system of claim 4 wherein the rigid camera mount is mounted on a selfie stick.

6. The stereo camera system of claim 4 wherein the rigid camera mount is mounted to a tripod.

7. The stereo camera system of claim 4 wherein the rigid camera mount is mounted to an unmanned aerial vehicle.

8. The stereo camera system of claim 4 wherein the trigger mechanism comprises a wired trigger mechanism connected to both the first camera and the second camera.

9. The stereo camera system of claim 4 wherein the trigger mechanism comprises a first wired trigger mechanism connected to the first camera and a second wired trigger mechanism connected between the first camera and the second camera.

10. The stereo camera system of claim 4 wherein the trigger mechanism comprises a first wired trigger mechanism connected to the first camera and a second wireless trigger mechanism connected wirelessly between the first camera and the second camera.

11. The stereo camera system of claim 4 wherein the trigger mechanism comprises a wireless trigger mechanism connected wirelessly to the first camera and the second camera in parallel.

12. The stereo camera system of claim 11 wherein the trigger mechanism comprises a wireless trigger mechanism wirelessly connected to the first camera and a wired trigger mechanism connected between the first camera and the second camera.

13. The stereo camera system of claim 4 wherein the trigger mechanism triggers both the first camera and the second camera at a same time to capture a first plurality of frames of video and a second plurality of frames of video, respectively, and wherein the processor executing the alignment tool aligns each frame of the first plurality of frames with a frame of the second plurality of frames to generate video data that can construct a three-dimensional video on a three-dimensional display.

14. The stereo camera system of claim 13 wherein the first camera tags each frame in the first plurality of frames with a respective timestamp and wherein the second camera tags each frame in the second plurality of time frames with a respective timestamp.

15. The stereo camera system of claim 14 wherein the respective timestamps are Global Positioning System timestamps.

16. The stereo camera system of claim 13 wherein the trigger mechanism uses an accurate time reference to synchronize the collection of frames of video by the first camera and the second camera.

17. The stereo camera system of claim 4 wherein the processor is in a separate computing device from the first camera and the second camera.

18. The stereo camera system of claim 4 wherein the first camera sends the first image wirelessly to the separate computing device and the second camera sends the second image wirelessly to the separate computing device.

19. A stereo camera comprising:
a first image sensor array aligned with a first camera aperture;
a second image sensor array aligned with a second camera aperture;
a shutter control linked to the first image sensor array and the second image sensor array such that activation of the shutter control causes the first image sensor array to capture first image data and causes the second image sensor array to capture second image data; and
a processor receiving the first image data and the second image data and constructing three-dimensional image data from the first image data and the second image data, the three-dimensional image data such that a corresponding image looks three-dimensional when the three-dimensional image data is applied to a three-dimensional display.

20. The stereo camera of claim 19 wherein the three-dimensional display is part of the stereo camera.
